(19) United States
(12) Patent Application Publication
(10) Pub. No.: US 2022/0009125 A1
(43) Pub. Date: Jan. 13, 2022

(54) AGGREGATE LOAD SENSOR FOR CONCRETE MANUFACTURING

(71) Applicant: NITROcrete IP, LLC, Fort Collins, CO (US)

(72) Inventor: Eric L. VAN DIXHORN, Fort Collins, CO (US)

(21) Appl. No.: 17/370,909

(22) Filed: Jul. 8, 2021

Related U.S. Application Data
(60) Provisional application No. 63/049,564, filed on Jul. 8, 2020.

(51) Int. Cl. B28C 5/46; G01G 11/04; G01B 11/06; B28C 7/06

(52) U.S. Cl. CPC B28C 5/468; B28C 7/06; G01B 11/0608; G01G 11/04

(57) ABSTRACT

Aspects involve controlling application of a coolant, such as liquid nitrogen, to an aggregate on a conveyance system based on detecting the presence of the aggregate on the conveyance system. A sensor, such as a load sensor, may be located on or near the conveyance system upstream from a dispensing system of the coolant. The load sensor may detect the presence of aggregate on the conveyance device and provide an indication of the presence to a controller. The controller may, in turn, control a dispensing system to either apply or prevent application of the coolant onto the aggregate in response to the output of the load sensor. Through controlling of the dispensing system based on detection of the presence of aggregate on the conveyance device, damage to the conveyance device may be avoided or prevented, prolonging the life of the conveyance device.

### CROSS-REFERENCE TO RELATED APPLICATION

This application is related to and claims priority under 35 U.S.C. § 119(e) from U.S. Patent Application No. 63/049,564 filed Jul. 8, 2020 entitled “Aggregate Load Sensor,” the entire contents of which is incorporated herein by reference for all purposes.

### TECHNICAL FIELD

Aspect of the present disclosure involve cooling aggregate for concrete manufacturing, and more particularly involves application of liquid nitrogen to an aggregate on a conveying system based on detecting the aggregate on a conveyor.

### BACKGROUND AND INTRODUCTION

Concrete is made from mixing cement with water. Concrete processing also involves mixing aggregate, typically sand and gravel or rock, with the cement and water. Mixing cement and water produces heat—it is an exothermic reaction. Proper curing of the concrete can be negatively affected when temperatures exceed various thresholds, and this issue is exacerbated by the exothermic reaction. Thus, techniques have been developed to cool the concrete, or some component of the concrete, so that the concrete is and remains cool enough to cure properly.

Liquid nitrogen has been used to cool the aggregate or the mixture in a mixing truck. For nitrogen to be in a liquid state, its temperature must be at or below −320° F. at atmospheric pressure. These extremely low temperatures can damage many concrete manufacturing components. For example, in a processing plant, conveyors move the aggregate to a mixing truck and the aggregate may be cooled as it is conveyed to the truck. However, liquid nitrogen can damage the conveyor components and the rubber conveyor belt itself if applied directly to the conveyor components when aggregate is not present. Care to prevent prolonged application of the liquid nitrogen to the conveyor components may prolong the usefulness of such components.

It is with these observations in mind, among others, that aspects of the present disclosure were conceived and developed.

### SUMMARY

One aspect of the present disclosure relates to a system for concrete manufacturing. The system may include a coolant dispensing system comprising a dispensing head for dispensing a coolant onto an aggregate being carried on a conveyance device, a controller in communication with the coolant dispensing system, the controller controlling dispensing of the coolant from the dispensing head, and a load sensor, in communication with the controller, detecting an amount of the aggregate on the conveyance device, wherein the controller dispenses the coolant from the dispensing head based on a signal from the load sensor.

In some aspects, the load sensor of the system may include a strain gauge load cell disposed below the conveyance device to detect a downward force on the conveyance device from the aggregate and an idler wheel translating the downward force on the conveyance device from the aggregate to the strain gauge load cell. In other aspects, the load sensor may include an optical sensor system that includes an emitter emitting an optical beam and a receiver of the optical beam, wherein interruption of the optical beam indicates an aggregate load on the conveyance device. In still other aspects, the load sensor may include a switch activated by loading of the conveyance device with the aggregate,

In some aspects, the coolant dispensing system may further include a coolant storage tank, a pipeline in fluid communication between the coolant storage tank and the dispensing head, and a controllable valve in the pipeline. Controlling dispensing of the coolant from the dispensing head may include transmitting a control signal to the valve of the coolant dispensing system to the coolant storage tank of the coolant dispensing system. The controller may dispense the coolant from the dispensing head based further on comparing the output of the load sensor to a trigger value, wherein dispensing of the coolant occurs when the output of the load sensor meets or exceeds the trigger value. The controller may receive the trigger value from a user interface in communication with the controller.

Another aspect of the present disclosure relates to a method for concrete manufacturing that includes controlling, by a controller and based on an output of an aggregate load sensor corresponding to an amount of aggregate carried by a conveyor system, dispensing of a coolant from a coolant storage system onto a concrete aggregate carried on the conveyor system. The load sensor may include a strain gauge load cell disposed below the conveyance device to detect a downward force on the conveyance device from the amount of aggregate and/or an optical sensor to detect a height of the amount of aggregate carried by the conveyor system.

The method may further include transmitting a control signal to a valve of the coolant storage system, the valve of a pipeline in fluid communication between a coolant storage tank and a dispensing head, receiving, via a user interface, a trigger value for dispensing of the coolant, and/or comparing the output of the aggregate load sensor to the trigger value, wherein dispensing of the coolant occurs when the output of the aggregate load sensor exceeds the trigger value. The method may also include causing to display, on the user interface, an indication of the output of the aggregate load sensor, the trigger value, and an indication of an operational state of the dispensing system. Prior to display, the method may include translating the output of the aggregate load sensor to a common format of the controller. Further, the method may include halting dispensing of the coolant from the coolant storage system when the output of the aggregate load sensor is less than the trigger value.

Still another aspect of the present disclosure relates to a tangible, non-transitory computer-readable media storing executable instructions that may be executed by a processing device. When executed, the instructions may cause the processing device to receive an output of an aggregate load sensor corresponding to an amount of aggregate carried by a conveyor system and control dispensing of a coolant from a coolant storage system onto a concrete aggregate carried on the conveyor system based on the received output of the aggregate load sensor.

These and other aspects of the present disclosure are discussed in more detail in the detailed description section that follows

### BRIEF DESCRIPTION OF THE FIGURES

The foregoing and other objects, features, and advantages of the present disclosure set forth herein should be apparent from the following description of particular embodiments of those inventive concepts, as illustrated in the accompanying drawings. The drawings depict only typical embodiments of the present disclosure and, therefore, are not to be considered limiting in scope.

FIG. 1 is a system for cooling aggregate, e.g., aggregate for use in a concrete mixture, according to one embodiment.

FIGS. 2A-2C are cross-section views of a first aggregate load sensor for use with an aggregate conveying and cooling system with varying levels of aggregate present on the conveying system and a resulting trigger indication corresponding to the various levels of aggregate on the conveying system according to one embodiment.

FIGS. 3A and 3B are cross-section views of a second aggregate load sensor for use with an aggregate conveying and cooling system with varying levels of aggregate present on the conveying system according to one embodiment.

FIG. 4 is a flowchart of a method for operation of an aggregate cooling system in response to an aggregate load sensor according to one embodiment.

FIG. 5 is a screenshot of a user interface for interacting with an aggregate load sensor of an aggregate cooling system according to one embodiment.

FIG. 6 depicts an exemplary computing system that may implement various services, systems, and methods discussed herein.

### DETAILED DESCRIPTION

Aspects of the present disclosure involve systems, apparatus, devices, methods, and the like, for controlling application of a coolant, such as liquid nitrogen, to an aggregate on a conveyance system, the control of the application based on detecting the presence of the aggregate on the conveyance system. In one implementation, a sensor, such as a load sensor, may be located on or near the conveyance system upstream from a dispensing system of the coolant onto the aggregate conveyed by a conveyance device, such as a conveyor belt. In operation, the load sensor may detect the presence of aggregate on the conveyance device and provide an indication of the presence to a controller. The controller may be configured to control a dispensing system to either apply or prevent application of the coolant onto the aggregate in response to the output of the load sensor. In one example, a trigger load sensor output may be received and used to determine whether the coolant is dispensed onto the aggregate. Load sensor output values that meet or exceed a threshold value may control one or more components of the dispensing system to apply coolant onto the aggregate conveyed on the conveyance device. Output values that are below the threshold or trigger value may cause the controller to prevent dispensing coolant onto the aggregate. In another example, the sensor provides a binary signal—either loaded or not loaded, to cause the controller to dispense the coolant from the dispensing system. In this manner, the controller may transmit control signals to the dispensing system to control the output of the coolant from the dispensing system based on signals received from the load sensor. Through controlling of the dispensing system based on detection of the presence of aggregate on the conveyance device, damage to the conveyance device may be avoided or prevented, prolonging the life of the conveyance device. Further, the system may optimally avoid application of coolant, such as liquid nitrogen, during times when application would simply be wasteful. Given that liquid nitrogen must be maintained at very low temperatures and the same takes energy, suboptimal liquid nitrogen application not only wastes the raw material but may also cause energy waste and other system inefficiencies.

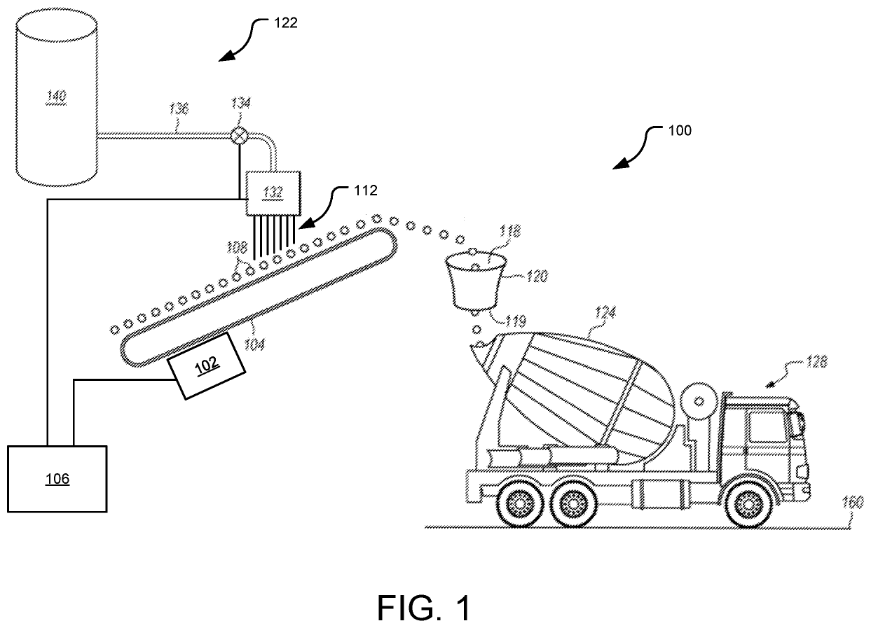

FIG. 1 illustrates an embodiment of a system 100 that can be used for cooling aggregate. In accordance with this embodiment, aggregate can be cooled by applying liquid nitrogen to the aggregate prior to entering a mixing chamber. By cooling the aggregate with liquid nitrogen prior to the aggregate being added to the mixing chamber, a significant cooling of the aggregate can be accomplished while reducing the concern of causing damage to the metal components of the mixing chamber. In the cooling system 100 of FIG. 1, an aggregate conveyance device 104 is used to convey the aggregate 108 or a mixture of aggregate and/or cement. It should be recognized that the arrangement of FIG. 1 is but one example of a liquid nitrogen based cooling system taking advantage of controlled liquid nitrogen activation, and the various control mechanisms discussed herein may be used to detect aggregate in various possible conveyance and liquid nitrogen dispensing arrangements. Returning to FIG. 1, the conveyance device 104 may be a conveyor belt or a chute, in some examples. In one instance, the conveyance device 104 transports the contents of the conveyor belt to an entry port 118 of a processing chute 120. The aggregate 108 or aggregate and cement mixture may travel through the chute 120 and out of an exit port 119 of the chute and into a mixing chamber 124 of a concrete mixing device (e.g., mixing chamber of a concrete mixing truck 128) positioned in a designated loading area 160 of a concrete batching plant. Further constituents, such as water and cement can also be added to the mixing chamber 124 and mixed together to form a concrete mixture.

The system 100 may include a cooling system to lower the temperature of the aggregate 108 on the conveyance device 104 prior to mixing in the mixing chamber 124 to improve the curing of the concrete. In one particular implementation, liquid nitrogen 112 may be disposed in the pathway of the aggregate 108 or aggregate and cement combination. In various implementations, different liquid nitrogen arrangements are possible that may provide a spray, a curtain, or other liquid nitrogen dispensing arrangements. Accordingly and in one example, a liquid nitrogen dispensing head may be positioned over the conveyance device 104 to provide a flow, a spray, or a curtain of liquid nitrogen 112 onto the aggregate 108 as carried by the conveyance device 104 somewhere along its travel along or from the end of the conveyance device to the entry port 118 of the chute 120. In some examples, a liquid nitrogen storage tank 140 may store and supply liquid nitrogen under pressure via pipeline 136 to a dispensing head for application on the aggregate 108. The dispensing head may, in some instances, be a dispensing head 132 or other device for applying liquid nitrogen onto the aggregate 108. Some particular embodiments of the dispensing head 132 are disclosed in U.S. patent application Ser. No. 15/882,795, filed Jan. 29, 2018, and 63/027,319, filed on May 19, 2020, the entirety of both of which are hereby incorporated by reference. A valve 134 may be in liquid communication with the pipeline 136 and used to control the flow of liquid nitrogen from the storage tank 140 to the dispensing head 132. The dispensing head 132 converts the pressurized input of liquid nitrogen to an unpressurized flow of liquid nitrogen 112 that may be dispensed from the dispensing head. An output port of the dispensing head 132 outputs the unpressurized liquid nitrogen 112 onto the aggregate 108 carried by the conveyance device 104 such that the aggregate can be carried through the spray of liquid nitrogen and cooled.

Because the liquid nitrogen dispensed by the dispensing head 132 is extremely cold, it can damage components of the batching equipment, such as metal or rubber parts of the conveyance device 104 or a metal chute system, particularly if the liquid nitrogen is dispensed onto the conveyance device 104 when aggregate 108 is not present, as the liquid nitrogen would contact the belt and other components of the conveyor as opposed to the aggregate. Therefore, controlling the flow of the liquid nitrogen 112 from the dispensing head 132 may improve the structural longevity of the conveyance device 104, and avoid various inefficiencies for applying liquid nitrogen when nothing is present on the conveyance device to be cooled. Therefore, in some instances, the cooling system 100 may include an aggregate load sensor 102 for detecting the presence of aggregate 108 on or otherwise being conveyed by the conveyance device 104. Various aggregate load sensors 102 may be integrated with the cooling system 100, as discussed in more detail below. An output providing an indication of aggregate 108 on the conveyance device 104 may be provided to a controller 106 which, in response to the output from the load sensor 102, may control flow of the liquid nitrogen 112 from the dispensing head 132. For example, the controller 106 may provide a control signal to the dispensing head 132, the valve 134, the tank 140, or any other control component of the cooling system 100 to start, increase, reduce, stop and/or otherwise control the flow of the liquid nitrogen 112 from the dispensing head onto the conveyance device 104. In one implementation described in more detail below, the controller 106 may receive one or more user settings via a user interface, such as a trigger value or other configuration setting, which may be utilized by the controller to customize control of the flow of liquid nitrogen 112 in response to signals from the load sensor.

In general, the load sensor 102 may be located on or near the conveyance device 104 upstream from the dispensing of the coolant 112 onto the aggregate 108 conveyed by the conveyance device. During operation, the load sensor 102 may detect the presence of aggregate 108 on the conveyance device 104 and provide an indication of such presence to the controller 106. In one example, a sensor initiates a signal or other transmission when aggregate 108 is detected the conveyance device 104 or released onto the conveyance device from a hopper or the like. In such an example, the signal from the sensor 102 may be considered binary with one state indicating aggregate 108 on the conveyance device 104 and the other state indicating no aggregate on the conveyance device. In some instances, the indication signal may include a measurement value of an amount of aggregate 108 on the conveyance device 104, such as a weight of aggregate and/or a height of piled aggregate. The controller 106 may be configured to provide application or dispensing of the liquid nitrogen 112 onto the aggregate 108 in response to the output (e.g., indication signal) of the load sensor 102. For example, the load sensor 102 may provide a signal or other indication to the controller 106 that aggregate 108 is detected on the conveyance device, or that no aggregate 108 is being conveyed by the conveyance device 104. In response, the controller 106 may control some component of the dispensing system 122 to start application or stop or prevent application, respectively, of the liquid nitrogen 112 onto the conveyance device 104 to prevent the liquid nitrogen from damaging the conveyance device. A similar control of the dispensing system 122 to stop or prevent application of the liquid nitrogen 112 may also occur for aggregate loads that are below a particular threshold value. For example, the load sensor 102 may provide an indication of a weight of the aggregate 108 on the conveyance device 104. The controller 106 may stop flow of the coolant 112 onto the aggregate 108 for load weights below a threshold weight value. A similar approach may be used for a pile height of the aggregate 108. For example, the sensor 102 may detect a height of a pile of aggregate 108 on the conveyance device 104 and, if the output value of the height sensor falls below a threshold value, the controller 106 may stop flow of the coolant 112 onto the conveyance device 104. For sensor 102 outputs that meet or exceed the threshold value, the controller 106 may control one or more components of the dispensing system 122 to begin application of the coolant 112 onto the aggregate 108 conveyed on the conveyance device 104. In this manner, the controller 106 may transmit control signals to the dispensing system 122 or other components of the cooling system 100 to control the output 112 of the dispensing system based on signals received from a load sensor 102. The control of the dispensing system 122 may prevent damage to the conveyance device 104 through application of the cooling liquid 112 onto the conveyance device when insufficient aggregate is present on the conveyance device, thereby preventing the coolant from hitting the conveyance device causing the damage.

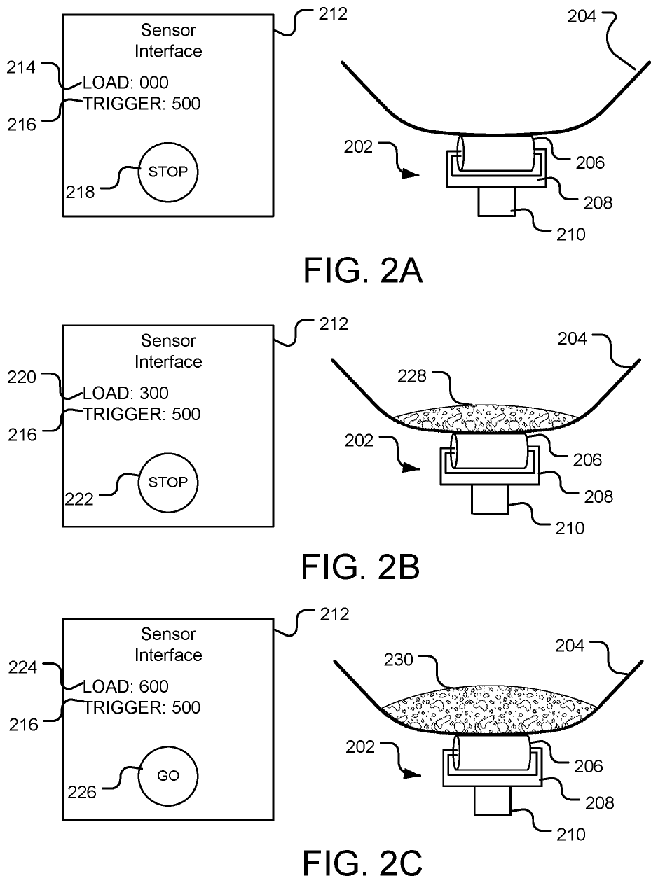

FIGS. 2A-2C are cross-section views of a first aggregate load sensor 202 for use with an aggregate conveying and cooling system 100 with varying levels of aggregate present on the conveyance device 204 and a resulting trigger indication corresponding to the various levels of aggregate on the conveyance device according to one embodiment. The conveyance device 204 of FIGS. 2A-2C may be similar to the conveyance device 104 discussed above with relation to FIG. 1. Further, the load sensor 202 may be one embodiment of the load sensor 102 discussed above to detect the presence or an amount of aggregate 108 on the conveyance device 104 for purposes of controlling application of a coolant 112 onto the aggregate on the conveyance device. Other embodiments of load sensors may be alternatively or simultaneously utilized to detect the aggregate 108 on the conveyance device 104, as discussed in more detail below.

In the instances illustrated in FIG. 2A, an aggregate load sensor 202 may be proximate the conveyance device 204, such as located below the conveyance device. As explained above, the load sensor 202 may be upstream of a coolant dispensing system 122. The particular embodiment of the load sensor 202 illustrated in FIGS. 2A-2C may include a force sensor, such as a strain gauge load cell 210, disposed below the conveyance device 204. In general, the load cell 210 may detect a force, such as a compression or pressure, applied to the cell and convert the detected force to an electrical output signal corresponding to the detected force. A C-shaped idler bracket 208 may connect the load cell 210 to an idler wheel 206 abutting an underside of the conveyance device 204. The idler wheel 206 may rotate about the idler bracket 208 such that the load sensor assembly 202 remains in place underneath the conveyance device 204 during operation of the conveyance device. In other words, the contact between the underside of the conveyance device 204 and the idler wheel 206 may cause the idler to rotate in the direction of the movement of the conveyance device 204, while translating any downward forces to the load cell 210 oriented below the idler wheel 206. Other embodiments of the load sensor 202 may use alternate constructions that translate a downward force or weight from material on the conveyance device 204 to a load cell 210 located below the conveyance device. The implementation illustrated is but one example of such a load sensor 202 to detect the presence of aggregate on the conveyance device 204.

As mentioned above with reference to FIG. 1, the load sensor 202 may communicate with a controller 106. More particularly, the load sensor 202 may provide an output corresponding to a detected downward force to the controller 106. The controller 106 may utilize the load sensor 202 output to control application of a coolant 112 onto the conveyance device 204. In the example illustrated in FIG. 2A, no aggregate is present on the conveyance device 204 such that application of coolant onto the conveyance device 204 may damage the device. Thus, the controller 106 may be configured to stop or prevent spraying of coolant onto the conveyance device 204 in response to the output from the load sensor 202. FIG. 2A also includes one example of a user interface 212 associated with the load sensor 202 displaying operation of the dispensing system 122 in response to the output received from the load sensor 202. In particular, the user interface 212 may include a “LOAD” indicator 214 corresponding to the output received from the load sensor 202. In the example of FIG. 2A, the load indicator 214 displays no measured load at the load sensor 202 corresponding to no aggregate being on the conveyance device 204. For example, the load indicator 214 may be displayed as “000” to indicate that the output of the load sensor 202 indicates no downward force on the load sensor. In some instances, the load sensor 202 may be calibrated with a tare weight or otherwise adjusted to disregard a weight of the conveyance device 204 measured by the load sensor 202. In other embodiments, the output of the load sensor 210 may indicate a measured weight of the conveyance device 204 which may be illustrated in the user interface 212 or more be removed by the controller 106 when displaying the measured load 214.

The user interface 212 may also include a trigger indicator 216 corresponding to a trigger output value from the load sensor 202. For example, the controller 106 may be configurable or adjustable to define or receive a trigger value corresponding to a particular load sensor 202 output value at which coolant from the dispensing system 122 may be dispensed. In general, any value of the load sensor 202 may be selected or determined as the trigger value 216. In one instance, a user of the system 100 may provide the trigger value 216 to the controller 106 via a user interface which may be selected based on a preference of amount of aggregate 108 on the conveyance device 204 for safe cooling. In other instances, the trigger value 216 may be predetermined by the controller 106 in response to monitored operation of the aggregate cooling system 100 or any other performance measurement of the system 100. In the example illustrated in FIG. 2A, the trigger value is set at “500” and corresponds to a particular output value received from the load sensor 202. For example, “500” may be a weight in pounds of aggregate on the conveyance device 204 at which cooling of the aggregate may begin. However, the trigger value 216 may be any number corresponding to an output value of the load sensor 202 and may not be an actual measurement of the weight of the aggregate. In general, the trigger value 216 may be any value selected by a user of the system or preset by the system for cooling of the aggregate 108. The user interface 212 may also include visual indication 218 of the operation of the dispensing system 122 in response to the received load measurement from the load sensor 202. In the example shown, because the received load value 214 is less than the trigger value 216, the indicator 218 displays a stopped operation of the dispensing system 122 in which coolant is not being dispensed by the dispensing system. In some instances, the operation indicator 218 may be colored, such as displayed in a red color, to further indicate the operational state of the dispensing system 122 in response to the output of the load sensor 202.

In the example illustrated in FIG. 2B, some amount of aggregate 228 is illustrated on, and being conveyed by, the conveyance device 204. The downward force of the weight of the aggregate 228 may be detected by the load sensor 202, more particularly the load cell 210 of the load sensor. In response to the presence of the aggregate 228 on the conveyance device 204, the load cell 210 may provide an output signal to the controller 106 corresponding the detected weight or downward force of the aggregate 228. The controller 106 may translate and/or display an indication of the load sensor 202 output in the user interface 212 as the “LOAD” 220. In this example, the load sensor 202 output is displayed as “300”, perhaps corresponding to 300 pounds of detected aggregate weight, although any value may be displayed on the display. Similar to above, the user interface 212 may also display the trigger value 216 at which cooling of the aggregate 228 may occur. In this example, the measured load value 220 remains less than the trigger value 216 such that coolant is not dispensed onto the aggregate 228 on the conveyance device 204. This is also displayed by operation indicator 222, as also described above. In this case, although some aggregate 228 is present on the conveyance device 204, the load sensor 202 output is not enough to trigger cooling of the aggregate. Thus, the trigger value 216 may prevent dispensing of the coolant 112 in situations where some aggregate 228 is present on the conveyance device 204 but not in quantities to prevent potential damage to the conveyance device by the coolant.

In the example illustrated in FIG. 2C, a second amount of aggregate 230 is illustrated on the conveyance device 204 for conveyance to a mixer. The downward force of the weight of the second amount of aggregate 230 may be detected by the load sensor 202, more particularly the load cell 210 of the load sensor, and displayed in the user interface 212, in a similar manner as described above. In this example, however, the load sensor 202 output is displayed as a “600” value corresponding to output received from the load sensor 202 and indicating a larger amount of aggregate on the conveyance device 204 than illustrated in FIGS. 2A and 2B. In this example, the measured load value 224 exceeds the trigger value 216 such that coolant may be dispensed onto the aggregate 230 on the conveyance device 204 in response to the sensor output value being equal to or more than the trigger value. More particularly, the controller 106 may control the valve 134, the dispensing head 132, or any other component or components of the dispensing system 122 to begin dispensing coolant 112 onto the aggregate 230 in response to the output of the sensor 202. In some instances, dispensing of the coolant 112 may be delayed by some time following the load sensor output meeting or exceeding the trigger value 216 to allow for the measured aggregate that triggers the dispensing to arrive beneath the dispensing head 132. An indication 226 of the dispensing operation of the system 100 may also be displayed in the user interface 212. In the example illustrated, a “GO” indicator 226 is displayed and may or may not be colored (such as in a green color) upon display to indicate that coolant may be dispensed by the dispensing system 122. In this manner, cooling of the aggregate 230 may be controlled by an output provided by the load sensor 202 such that cooling occurs upon the detected amount of aggregate on the conveyance device 204 meeting or exceeding a threshold trigger value 216. This may prevent coolant 112 from being dispensed onto the conveyance device 204 and potentially damaging the device if aggregate is not present or insufficiently present on the conveyance device.

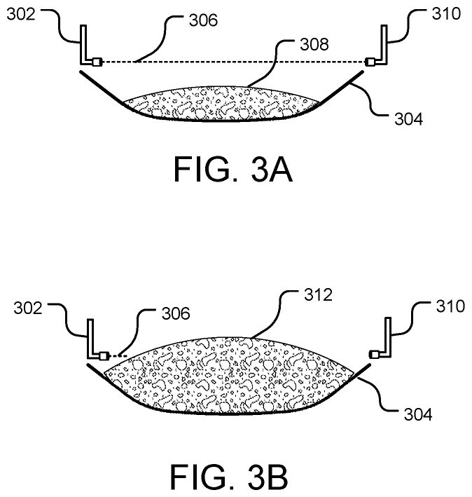

The load sensor 202 of FIGS. 2A-2C is but one example of a load sensor that may be used to determine a sufficient amount of aggregate on the conveyance device 204 to begin cooling of the aggregate. In general, any sensor may be used to detect the amount of aggregate on the conveyance device 204. For example, an optical or other visual-based sensor may be oriented detect the presence of a light beam corresponding to aggregate on the conveyance device 204. FIGS. 3A and 3B are cross-section views of a second aggregate load sensor for use with an aggregate conveying and cooling system with varying levels of aggregate present on the conveying system according to one embodiment. The implementations of FIGS. 3A and 3B include a light or optical sensor system to detect a height of aggregate on the conveyance device. In particular, an emitter 302 of an optical sensor system may be oriented above the conveyance device 304 on which aggregate 308 may or may not be carried. The emitter 302 may emit a light beam 306 or other optically-detectable emission. A receiver 310 may be oriented across the conveyance device 304 to receive the emitted light beam 306. In one example, the light beam 306 may be projected across the conveyance device 304 at a level corresponding to sufficient aggregate for the cooling operation. When the light beam is interrupted by the presence of aggregate 312 on the conveyance device 304 as shown in FIG. 3B, the optical sensor 302, 310 may provide an electrical signal to the controller 106 to indicate the presence of a sufficient amount of aggregate 312 on the conveyance device 304 for cooling. In other words, the interruption of the light beam 306 by the aggregate 312 may indicate that enough aggregate is on the conveyance device 304 such that cooling of the aggregate may not damage the conveyance device. An aggregate pile that falls below the light beam 306 height may cause the receiver 310 to receive the light beam, generating a detection signal to the controller 106 indicating a smaller pile of aggregate. The controller 106 may, in turn, halt dispensing of the coolant onto the aggregate until the light beam 306 is interrupted again by the aggregate pile.

In another example, a physical switch may be integrated into the conveyance device 104 or to an aggregate dispenser that provides the aggregate to the conveyance device such that activation of the physical switch indicates that aggregate is present on the conveyance device. The position of the switch may be communicated to the controller 106 from which operation of the cooling system 122 may be controlled. Other types of sensors may be integrated into the cooling system 100 for detection of aggregate 108 on the conveyance device 104 and providing one or more outputs to the control system 106 for control of the dispensing system 122 as described above.

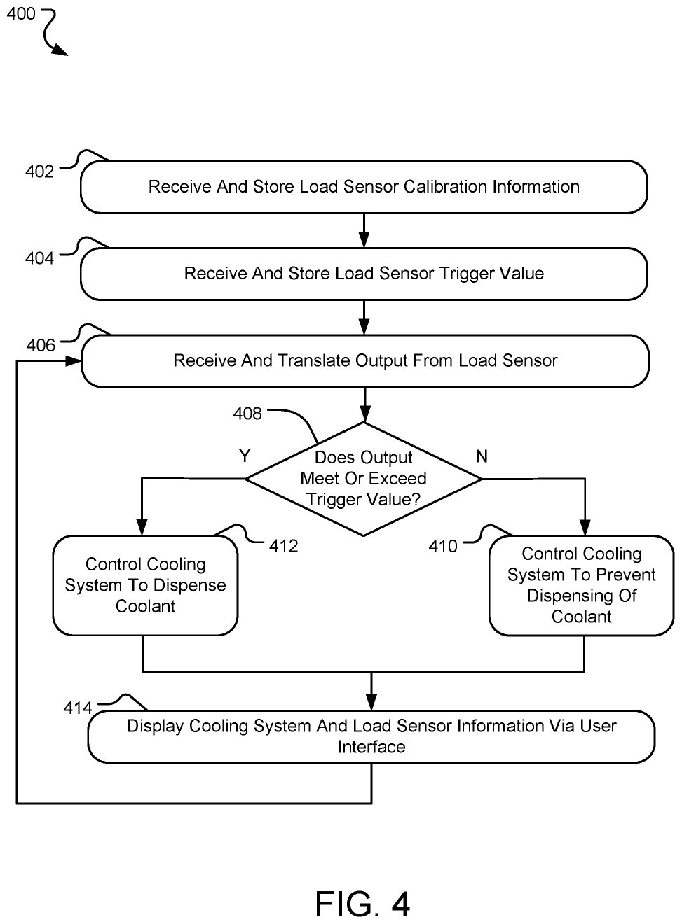

FIG. 4 is a flowchart of a method 400 for operation of an aggregate cooling system 100 in response to an aggregate load sensor 102 according to one embodiment. In one implementation, the operations of the method 400 may be performed by the controller or control system 106 of the aggregate cooling system 100. In other implementations, one or more operations of the method 400 may be performed by other components of the cooling system 100 or components of a concrete batch processing plant of which the cooling system 100 is integrated. The operations may be executed via hardware components, software programs, or a combination of hardware and software components.

Beginning in operation 402, the controller 106 may receive and store load sensor calibration information. For example and as described above, the load sensor 102 of the system 100 may be calibrated to remove a tare weight on the load sensor such that the output signal from the load sensor indicates only a weight of the aggregate 108 and not a weight of the conveyance device 104. Other calibrations may be made to account for variances in the installation of the load sensor 102 on the conveyance device 104 such that the output from the load sensor may only indicate the presence of the aggregate on the conveyance device. For example, a height of a light beam and/or optical sensor may be calibrated to account for a diminishing light beam intensity due to dust or other particles in the air as aggregate is loaded onto and carried by the conveyance device. The received calibrations may be stored by the controller 106 to provide an operational baseline for detecting aggregate on the conveyance device 104.

In operation 404, the controller 106 may receive and store a threshold or trigger value of the load sensor 102. As explained above, the trigger value may correspond to an output of the load sensor 102 at which the controller 106 may control the dispensing system 122 to dispense coolant 112 onto the aggregate 108. The trigger value may be based on many factors, including but not limited to, operational trial and error sessions conducted on the cooling system 100, operator-selected trigger values, machine-learning of optimized trigger values, trigger values received from a remote storage or database, inputs provided via the user interface, and the like. In some instances, a hysteresis value may also be received and stored by the controller 106. In general, the hysteresis value may be a delay in time for the controller 106 to switch from one operating state to another, such as from a not dispensing coolant state to a dispensing coolant state. The hysteresis value may be utilized to prevent rapid transitions between dispensing/not dispensing operating states of the dispensing system 122 for load sensor 102 output values occurring around the trigger value. Further, as explained above, a delay in activating the dispensing system 122 may be received and stored at the controller 106 to allow the measured aggregate at the position of the load sensor 102 sufficient time to be conveyed by the conveyance device 104 to a position below the dispensing head 132. In other words, because the load sensor 102 may be located upstream from the dispensing head 132, the controller 106 may delay dispensing of coolant from the dispensing head 132 until the detected aggregate is below the dispensing head. The delay used by the controller 106 may be based on or correspond to the speed of the conveyance device 104 such that the controller 106 may receive an input or other information indicating an estimated or actual speed of the conveyance device 104. With the provided speed information and a known distance between the sensor 102 and the dispensing head 132, the controller 106 may calculate a delay for dispensing the coolant 112 onto the aggregate 108. These and other adjustments/configurations of the load sensing system may be received and stored by the controller 106.

The controller 106 may begin receiving output signals from the load sensor 102 in operation 406. As explained above, the load sensor 102 may transmit or otherwise generate an output signal corresponding to a level of detection of aggregate 108 on the conveyance device 104. In one example, the load sensor 102 may provide an output corresponding to a weight of aggregate 108 present on the conveyance device 104. The output from the load sensor 102 may also be translated by the controller 106 to normalize the output to a common format or range of values. For example, a detected weight of 100 lbs. of aggregate 108 on the conveyance device 104 may be translated to a value of “10” by the controller 106. In general, the outputs received from the sensor 102 may be translated into any value or format by the controller 106. In this manner, a controller 106 may be configured to receive outputs from different types of load sensors 102 and normalize the outputs to a common format and/or values for processing by the controller 106 and display via the user interface.

The controller 106 may determine, in operation 408, if the received output value from the load sensor 102 meet or exceed the trigger value associated with the cooling system 100. As mentioned above, the trigger value may be received from a user interface to the controller 106 or may be learned by the controller through a trial-and-error process or through one or more machine learning processes. If the received output value does not meet or exceed the threshold value, the controller 106 may control the dispensing system 122 to prevent dispensing coolant 112 onto the aggregate 108 in operation 410. The controller 106 may prevent dispensing of the coolant 112 through generation and transmission of one or more control signals to one or more components of the dispensing system 122, such as valve 144, dispensing head 142, and/or tank 140. Alternatively, if the received output value meets or exceeds the threshold value, the controller 106 may control the dispensing system 122 to dispense coolant 112 onto the aggregate 108 in operation 412. Dispensing of the coolant 112 may occur through generation and transmission of one or more control signals to one or more components of the dispensing system 122, such as valve 144, dispensing head 142, and/or tank 140 to begin dispensing. As explained above, a hysteresis and/or delay may occur in dispensing coolant or preventing dispensing of coolant onto the aggregate 108.

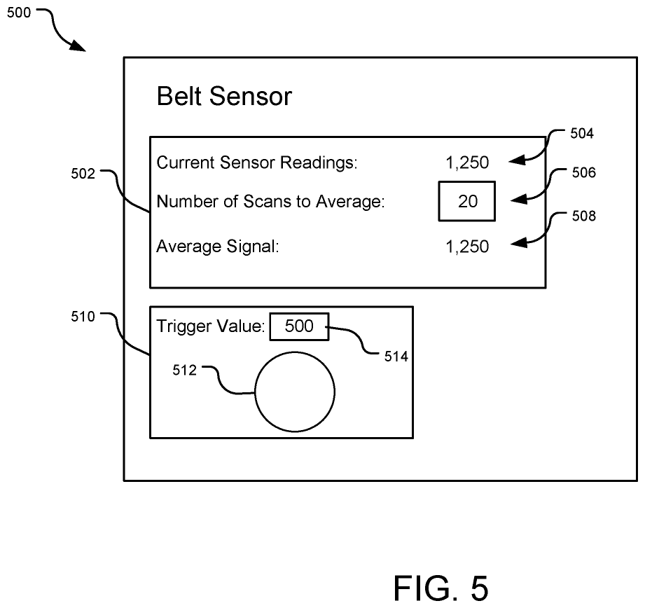

In operation 414, the controller 106 may display information of the cooling system 100 and/or load sensor 102 via a user interface. In particular, FIG. 5 is a screenshot of a user interface 500 for interacting with an aggregate load sensor 102 of an aggregate cooling system 100 according to one embodiment. In the example shown, the user interface 500 may include a first portion 502 which displays a current sensor reading 504 corresponding to an output transmitted by the load sensor 102 in response to the presence of aggregate 108 on the conveyance device 104. The displayed current sensor reading 504 may be a value output by the load sensor 102 or may be a translated value based on the output of the load sensor 102. The user interface 500 may also include a second portion 510 including a dispensing system operation indicator 512, similar to that described above. In one implementation, the indicator 512 may include a color, such as red for prevention of dispensing of the coolant 112 and green indicating a dispensing operation. Other types of indicators of the dispensing system 122 may also be included in the user interface 500. For example, the user interface 500 may also provide an input box 514 in which a user of the interface may enter a trigger value for use as described above. The user may provide the trigger value in the input box 514 through any input device of a computing system executing or displaying the user interface 500, as explained below. In addition, the user interface 500 may include a calculation of an average of multiple sensor readings 508 over a number of sensor readings or a period of time. An input box 506 for adjusting the number of readings to be averaged may also be provided. The averaged sensor readings 508 may be used to calibrate or adjust the load sensor output at the controller 106 as discussed above. More or fewer inputs and information may be provided via the user interface 500 associated with the load sensor 102. Returning to the method 400 of FIG. 4, the controller 106 may, after displaying information via the user interface, return to operation 406 to receive and translate additional output from the load sensor 102. In this manner, the controller 106 may control dispensing of the coolant 112 in response to outputs from the load sensor 102 to avoid damaging the conveyance device 104.

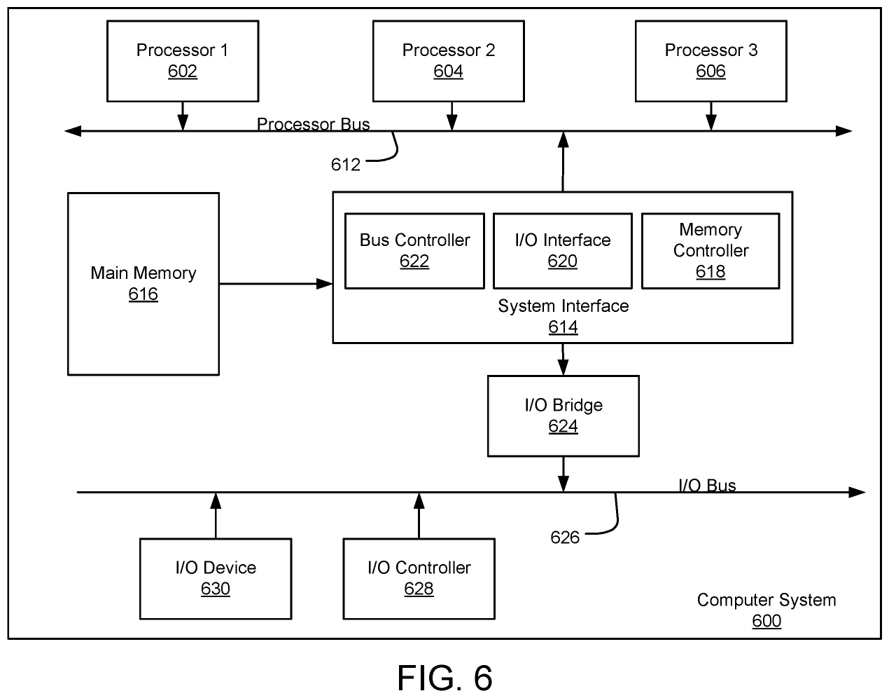

FIG. 6 is a block diagram illustrating an example of a computing device or computer system 600 which may be used in implementing the embodiments of the components of the network disclosed above. For example, the computing system 600 of FIG. 6 may be the controller 106 of the cooling system 100 discussed above. The computer system (system) includes one or more processors 602-606. Processors 602-606 may include one or more internal levels of cache (not shown) and a bus controller or bus interface unit to direct interaction with the processor bus 612. Processor bus 612, also known as the host bus or the front side bus, may be used to couple the processors 602-606 with the system interface 614. System interface 614 may be connected to the processor bus 612 to interface other components of the system 600 with the processor bus 612. For example, system interface 614 may include a memory controller 618 for interfacing a main memory 616 with the processor bus 612. The main memory 616 typically includes one or more memory cards and a control circuit (not shown). System interface 614 may also include an input/output (I/O) interface 620 to interface one or more I/O bridges or I/O devices with the processor bus 612. One or more I/O controllers and/or I/O devices may be connected with the I/O bus 626, such as I/O controller 628 and I/O device 630, as illustrated.

I/O device 630 may also include an input device (not shown), such as an alphanumeric input device, including alphanumeric and other keys for communicating information and/or command selections to the processors 602-606. Another type of user input device includes cursor control, such as a mouse, a trackball, or cursor direction keys for communicating direction information and command selections to the processors 602-606 and for controlling cursor movement on the display device.

System 600 may include a dynamic storage device, referred to as main memory 616, or a random access memory (RAM) or other computer-readable devices coupled to the processor bus 612 for storing information and instructions to be executed by the processors 602-606. Main memory 616 also may be used for storing temporary variables or other intermediate information during execution of instructions by the processors 602-606. System 600 may include a read only memory (ROM) and/or other static storage device coupled to the processor bus 612 for storing static information and instructions for the processors 602-606. The system set forth in FIG. 6 is but one possible example of a computer system that may employ or be configured in accordance with aspects of the present disclosure.

According to one embodiment, the above techniques may be performed by computer system 600 in response to processor 604 executing one or more sequences of one or more instructions contained in main memory 616. These instructions may be read into main memory 616 from another machine-readable medium, such as a storage device. Execution of the sequences of instructions contained in main memory 616 may cause processors 602-606 to perform the process steps described herein. In alternative embodiments, circuitry may be used in place of or in combination with the software instructions. Thus, embodiments of the present disclosure may include both hardware and software components.

A machine readable medium includes any mechanism for storing or transmitting information in a form (e.g., software, processing application) readable by a machine (e.g., a computer). Such media may take the form of, but is not limited to, non-volatile media and volatile media and may include removable data storage media, non-removable data storage media, and/or external storage devices made available via a wired or wireless network architecture with such computer program products, including one or more database management products, web server products, application server products, and/or other additional software components. Examples of removable data storage media include Compact Disc Read-Only Memory (CD-ROM), Digital Versatile Disc Read-Only Memory (DVD-ROM), magneto-optical disks, flash drives, and the like. Examples of non-removable data storage media include internal magnetic hard disks, SSDs, and the like. The one or more memory devices 606 may include volatile memory (e.g., dynamic random access memory (DRAM), static random access memory (SRAM), etc.) and/or non-volatile memory (e.g., read-only memory (ROM), flash memory, etc.).

The description above includes example systems, methods, techniques, instruction sequences, and/or computer program products that embody techniques of the present disclosure. However, it is understood that the described disclosure may be practiced without these specific details. In the present disclosure, the methods disclosed may be implemented as sets of instructions or software readable by a device. Further, it is understood that the specific order or hierarchy of steps in the methods disclosed are instances of example approaches. Based upon design preferences, it is understood that the specific order or hierarchy of steps in the method can be rearranged while remaining within the disclosed subject matter. The accompanying method claims present elements of the various steps in a sample order, and are not necessarily meant to be limited to the specific order or hierarchy presented.

Various modifications and additions can be made to the exemplary embodiments discussed without departing from the scope of the present invention. For example, while the embodiments described above refer to particular features, the scope of this invention also includes embodiments having different combinations of features and embodiments that do not include all of the described features. Accordingly, the scope of the present invention is intended to embrace all such alternatives, modifications, and variations together with all equivalents thereof.

While specific implementations are discussed, it should be understood that this is done for illustration purposes only. A person skilled in the relevant art will recognize that other components and configurations may be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and, such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any example term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

What is claimed is:

1. A system for concrete manufacturing, the system comprising:
a coolant dispensing system comprising a dispensing head for dispensing a coolant onto an aggregate being carried on a conveyance device;
a controller in communication with the coolant dispensing system, the controller controlling dispensing of the coolant from the dispensing head; and
a load sensor, in communication with the controller, detecting an amount of the aggregate on the conveyance device, wherein the controller dispenses the coolant from the dispensing head based on a signal from the load sensor.

2. The system of claim 1, wherein the load sensor comprises:
a load cell disposed below the conveyance device to detect a downward force on the conveyance device from a weight of the aggregate.

3. The system of claim 2, wherein the load sensor further comprises:
an idler wheel translating the downward force on the conveyance device from the weight of the aggregate to the load cell.

4. The system of claim 3, wherein the idler wheel contacts a bottom surface of the conveyance device and translates a downward displacement of the conveyance device from the weight of the aggregate to compress the load cell.

5. The system of claim 4, wherein the idler wheel rotates about a bracket in the direction of the movement of the conveyance device through the contact with the bottom surface of the conveyance device.

6. The system of claim 1, wherein the load sensor comprises an optical sensor system.

7. The system of claim 6, wherein the optical sensor system comprises:
an emitter emitting an optical beam; and
a receiver of the optical beam, wherein interruption of the optical beam causes a transmission of a signal to the controller indicating an aggregate load on the conveyance device.

8. The system of claim 1, wherein the coolant dispensing system further comprises:
a coolant storage tank;
a pipeline in fluid communication between the coolant storage tank and the dispensing head; and
a controllable valve in the pipeline.

9. The system of claim 8, wherein controlling dispensing of the coolant from the dispensing head comprises transmitting a control signal to the valve of the coolant dispensing system.

10. The system of claim 8, wherein controlling dispensing of the coolant from the dispensing head comprises transmitting a control signal to the coolant storage tank of the coolant dispensing system.

11. The system of claim 1, wherein the controller dispenses the coolant from the dispensing head based further on comparing an output value of the load sensor to a trigger value, wherein dispensing of the coolant occurs when the output value of the load sensor meets or exceeds the trigger value.

12. The system of claim 11, wherein the controller receives the trigger value from a user interface in communication with the controller.

13. A method for concrete manufacturing comprising:
controlling, by a controller and based on an output of an aggregate load sensor corresponding to an amount of aggregate carried by a conveyor system, dispensing of a coolant from a coolant storage system onto a concrete aggregate carried on the conveyor system.

14. The method of claim 13, wherein the load sensor comprises a load cell disposed below the conveyance device to detect a downward force on the conveyance device from a weight of the amount of aggregate.

15. The method of claim 13, wherein load sensor comprises an optical sensor to detect a height of the amount of aggregate carried by the conveyor system.

16. The method of claim 13 further comprising:
transmitting a control signal to a valve of the coolant storage system, the valve of a pipeline in fluid communication between a coolant storage tank and a dispensing head.

17. The method of claim 13 further comprising:
receiving, via a user interface, a trigger value for dispensing of the coolant; and
comparing the output of the aggregate load sensor to the trigger value, wherein dispensing of the coolant occurs when the output of the aggregate load sensor exceeds the trigger value.

18. The method of claim 17 further comprising:
causing to display, on the user interface, an indication of the output of the aggregate load sensor, the trigger value, and an indication of an operational state of the dispensing system.

19. The method of claim 18 further comprising:
translating, prior to display, the output of the aggregate load sensor to a common format of the controller.

20. The method of claim 17 further comprising:
halting dispensing of the coolant from the coolant storage system when the output of the aggregate load sensor is less than the trigger value.

21. A tangible, non-transitory computer-readable media storing executable instructions that, when executed by a processing device, cause the processing device to:
receive an output of an aggregate load sensor corresponding to an amount of aggregate carried by a conveyor system; and
control dispensing of a coolant from a coolant storage system onto a concrete aggregate carried on the conveyor system based on the received output of the aggregate load sensor.
